(19) United States
(12) Patent Application Publication
(10) Pub. No.: US 2011/0007881 A1
(43) Pub. Date: Jan. 13, 2011

(54) Method and Device for Accessing Voicemail Commands

(75) Inventors: Toshihiro Fujimura, Chicago, IL (US); Claudio Santiago Ribeiro, Evanston, IL (US)

Correspondence Address: MOTOROLA MOBILITY, INC, 600 NORTH US HIGHWAY 45, W2-55BB, LIBERTYVILLE, IL, 60048-5343, US

(73) Assignee: MOTOROLA, INC., Schaumburg, IL (US)

(21) Appl. No.: 12/498,459

(22) Filed: Jul. 7, 2009

(51) Int. Cl. H04M 1/64; G06F 3/041

(52) U.S. Cl. 379/88.23; 345/173

(57) ABSTRACT

A communication device (100) for accessing voicemail commands is disclosed. The device includes a user interface (130, 150) for receiving an input and detecting whether the input is associated with dialing a voicemail number and a display (150) for displaying a voicemail virtual touch pad in response to detecting that the input is associated with dialing a voicemail number, wherein the voicemail virtual touch pad comprises of a plurality of keys and wherein each key from the plurality of keys is associated with a corresponding voicemail command.

### FIELD OF THE DISCLOSURE

The present disclosure relates generally to communication devices that have access to a voicemail system and more particularly to a method for accessing voicemail commands on the communication device.

### BACKGROUND

A voicemail system is a centralized system for managing telephone messages for a large group of users. At times, this term is also used more broadly, to denote any system of conveying voice message, including the answering machine. Among various functions, the voicemail system is used for storing voice messages for a called party, when the called party's communication device is either busy or unanswered. In that case, the calling party can store a detailed voice message in calling party's own voice in a database of the voicemail system for the called party. These voice messages can be retrieved by the called party according to its own convenience from the voicemail system.

For retrieving the voice messages from the voicemail system, the called party dials a voicemail number. In one example, the voicemail number is unique for each user. In another example, the voicemail number is same for all users. However, each user has a unique password to access his/her voicemail account and retrieve voice messages destined for the particular user.

When the user dials a voicemail number, the voicemail system provides various options of voicemail commands to the user, orally. The user is asked to press a numeric key (for example, 1, 2, 3 . . . 9) from a keypad of the communication device corresponding to a voicemail command in order to execute the particular voicemail command. However, the user does not know or remember which numeric key corresponds to which voicemail command. This creates confusion if the user enters an incorrect numeric key. This also leads in delay, as the user has to wait for the voicemail system to repeat the numeric keys associated with each voicemail command again.

Accordingly, there is a need for a method and device for accessing voicemail commands.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a communication device for accessing voicemail commands in accordance with some embodiments.

FIG. 3 is a layout of a default virtual touch pad in accordance with some embodiments.

FIG. 3 is a layout of a voicemail virtual touch pad in accordance with some embodiments.

FIG. 4 is a flowchart of a method of accessing voicemail commands in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

A communication device for accessing voicemail commands is disclosed. The device comprises a user interface and a display. The user interface receives an input and detects whether the input is associated with dialing a voicemail number. The display displays a voicemail virtual touch pad in response to detecting that the input is associated with dialing a voicemail number. The voicemail virtual touch pad comprises of a plurality of keys in which each key from the plurality of keys is associated with a corresponding voicemail command.

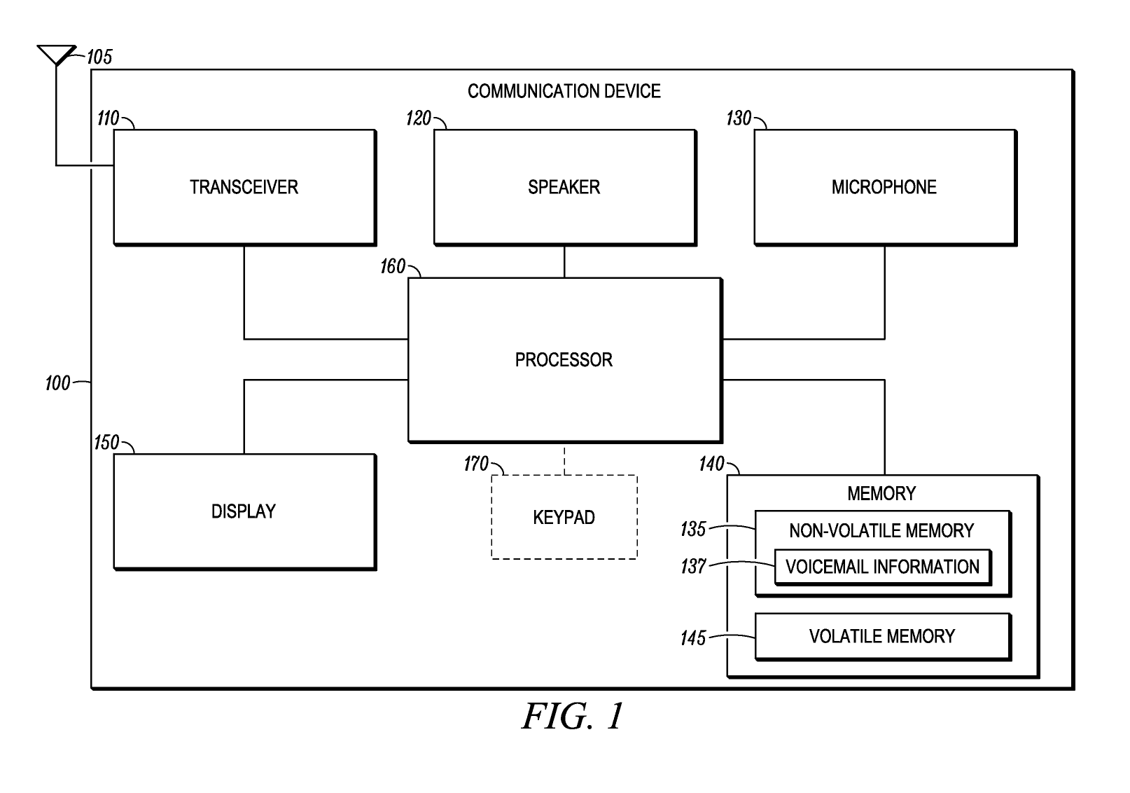

FIG. 1 is a block diagram of a communication device 100 for accessing voicemail commands in accordance with some embodiments. The communication device 100 may be a wireless device or a wired device having access to a voicemail system. In the example of FIG. 1, the communication device 100 is a wireless communication device. The communication device 100 includes an antenna 105, a transceiver 110, a speaker 120, a microphone 130, a display 150, a memory 140, and optionally a keypad 170 in which each may be coupled to a processor 160. In case, if the communication device 100 is a wired communication device then the device will include all the components such as a transceiver, a speaker, a microphone, a display, and a memory, except an antenna.

The microphone 130 is responsible for converting received audio signals from a user of the communication device 100 into electrical signals for transmission, and the speaker 120 is responsible for converting incoming electrical signals into audio signals for reception to the user of the communication device 100. The transceiver 110 is used for transmitting and receiving the signals using the antenna 105. The display is used for displaying various visuals including different touch pads to the user of the communication device. The touch pads are touch-sensitive screen overlaying or integral to the display 150. In addition, to the touch pads on the display 150, the communication device may also include a keypad 170. The physical keypad 170 is a conventional keypad with various fixed keys for receiving user input. The physical keypad 170 may include keys for accepting or declining an incoming call, a delete or cancel key, navigation keys, etc. The speaker 120, microphone 130, the physical keypad 170, and the display 150 are also commonly called as user interfaces, as they allow the user of the communication device 100 to interface with the device 100.

The memory 140 includes a volatile memory 145 and a non-volatile memory 135. The volatile memory 145 is used for storing temporary data that is erased every time the communication device 100 is powered OFF. The non-volatile memory is used for storing permanent type of data, which may also include program codes, phone book, messages, etc. The non-volatile memory 135 further stores voicemail information 137. Voicemail information 137 includes various voicemail numbers and various voicemail touch pads corresponding to each voicemail number.

Initially, after power ON or when the user unlocks the device 100, the display 150 displays a default virtual touch pad similar to the one shown in FIG. 2. FIG. 2 is a layout of a default virtual touchpad 230 on a display 250 (similar to display 150, shown in FIG. 1) of a communication device 200 (similar to communication device 100, shown in FIG. 1). The default virtual touch pad 230 includes various numeric keys 240 (such as 1, 2, 3 . . . , 9) as well as asterisk (*) and (#) keys. These keys are similar to the fixed keys available in any wired or wireless communication device. The communication device 200 also includes a keypad 270, which includes various fixed keys for accepting or declining an incoming call, a delete or cancel key, and navigation keys. The keypad 270 may include more keys depending upon the requirement and the manufacturer of the communication device 200.

Returning back to FIG. 1, a user interface (such as the microphone 130 or the display 150) receives an input from the user. In one example, the input may be a number spoken by the user into or near to the microphone 130. In another example, the input may be a number inputted by the user using the default virtual touch pad displayed on the display 150. The user interface receives the input and detects whether the input is associated with dialing a voicemail number. In one example, the input may be the voicemail number. In another example, the input may be a pre-determined voice command or a pre-determined sequence of keys from the default virtual touch pad or the keypad 170 that triggers dialing of the voicemail number.

If the input is determined to be associated with dialing the voicemail number, then the processor 160 correlates the dialed voicemail number to a corresponding voicemail virtual keypad from the voicemail information 137 of the memory 140. In one example, the voicemail information 137 of the memory 140 may store various voicemail virtual touch pads associated with various voicemail numbers. There may be a first voicemail number associated with a first virtual touch pad, a second voicemail number associated with a second virtual voicemail touch pad, and so on. The voicemail information 137 of the memory 140 also stores a list including a corresponding voicemail command associated with each key from a plurality of keys for every voicemail virtual touch pad. For example, the list indicates which voicemail command (such as, rewind, pause, fast forward, slower, data/time, faster, delete, reply, save, cancel/exit, help, and finish/skip) is associated with which key from the various keys displayed on the touch pad.

In one example, this list is stored in the memory 140 by the user of the device 100. In another example, this list is stored in memory by a manufacturer of the device 100. In yet another example, the processor 160 downloads the list using the antenna 105 and the transceiver 110 from a network to which the device 100 is connected and then stores the list in the memory 140. In a first case, the processor 160 downloads the list from the network upon power ON of the communication device 100. In a second case, the processor 160 downloads the list from the network, whenever the device connects to the network. In a third case, the processor 160 downloads the list from the network upon receiving a trigger in form of an input from the user of the device 100.

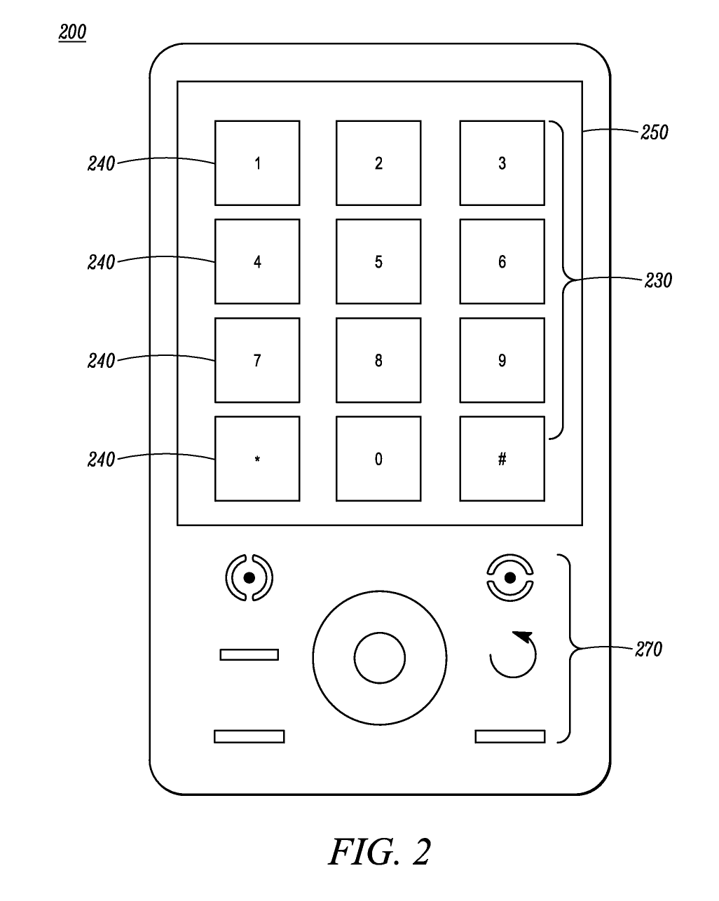

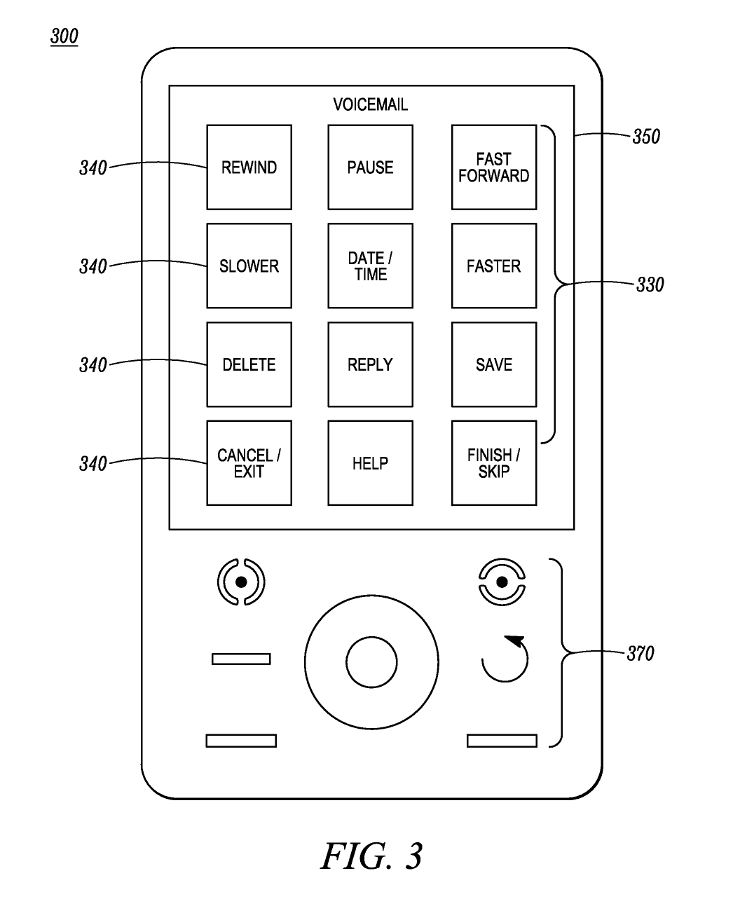

After the user interface detects that the input is associated with dialing a voicemail number, the processor 160 correlates the voicemail number to a voicemail virtual touch pad stored in the voicemail information 137 of the memory 140. The processor 160 then retrieves the voicemail virtual touch pad from the memory 140, which further includes retrieving the list from the memory 140 and configuring each key from the plurality of keys of the virtual voicemail touch pad with the corresponding voicemail command based on the list. After retrieving, the processor 160 sends the voicemail virtual touch pad to the display 150. Subsequently, the display 150 displays the voicemail virtual touch pad. An example layout of a voicemail virtual touch pad is shown in FIG. 3.

FIG. 3 is a layout of a default virtual touchpad 330 on a display 350 (similar to display 150, shown in FIG. 1) of a communication device 300 (similar to communication device 100, shown in FIG. 1). The voicemail virtual touch pad 330 includes a plurality of keys 340. In the example of FIG. 3, the plurality of keys 340 includes rewind, pause, fast forward, slower, data/time, faster, delete, reply, save, cancel/exit, help, and finish/skip. As already known in the art, rewind is used for rewinding a voice message and fast forward is used for forwarding the voice message. Slower is used for decreasing the rate of speech in the voice message and faster is used for increasing the rate of speech in the voice message. Date/time is used to display, either visually or orally, the date and time when the voice message was received. Delete is used for deleting the voice message, reply is used for replying to a calling party who left the voice message, save is used for saving the voice message, cancel/exit is used for exiting and returning back to the default virtual touch pad, help is used for indicating to the voicemail system that the user needs more help, and finish/skip is used for instantaneously finishing the voice message and moving to the next voice message. The communication device 300 also includes a keypad 370, which includes various fixed keys for accepting or declining an incoming call, a delete or cancel key, and navigation keys. The keypad 370 may include more keys than discussed in this example, depending upon the requirement and the manufacturer of the communication device 300.

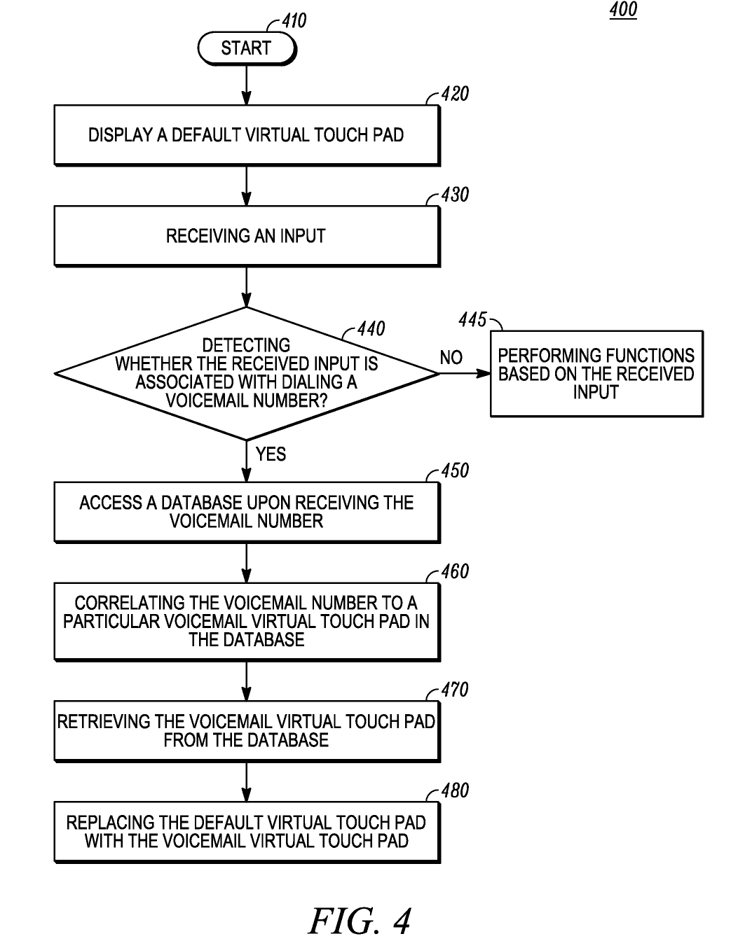

Returning back to FIG. 1, the display 150 displays the voicemail virtual touch pad as shown in FIG. 4. The transceiver 110 using the antenna 105, in case if the communication device 100 is a wireless communication device, communicates with the voicemail system associated with the voicemail virtual touch pad. For example, whenever the user of the communication device 100 presses any key from the plurality of keys of the voicemail virtual touch pad, the transceiver 110 using the antenna 105 sends the user's choice to the voicemail system and the voicemail system functions accordingly.

Therefore, by displaying the voicemail commands on a voicemail virtual touch pad, the user does not have to remember which numeric key corresponds to which voicemail command. This eliminates confusion of the user and the probability of entering an incorrect voicemail command by choosing a wrong numeric key. This also eliminates delay as the user does not have to wait for the voicemail system to repeat the numeric keys associated with each voicemail command again.

FIG. 4 is a flowchart of a method 400 of accessing voicemail commands in accordance with some embodiments. The method starts 410 when a communication device displays 420 a default virtual touch pad as the one shown in FIG. 2.

The device receives 430 an input by a user of the communication device. The device then detects 440 whether the received input is associated with dialing a voicemail number. In one example, the input may be a number spoken by the user into or near a microphone of the communication device. In another example, the input may be a number inputted by the user using the default virtual touch pad displayed on the display. The input may also be the voicemail number or a pre-determined voice command or a pre-determined sequence of keys from the default virtual touch pad or a keypad of the device that triggers dialing of the voicemail number.

If the device detects that the received input is not associated with dialing the voicemail number, then the device performs functions 445 associated with the received input. For example, if the received input is a telephone number of another user, then the device calls the dialed telephone number.

Otherwise, if the device detects that the received input is associated with dialing the voicemail number, then the device accesses 450 a database (such as a memory of the device) upon receiving the voicemail number. The database may store various voicemail virtual touch pads associated with various voicemail numbers. There may be a first voicemail number associated with a first virtual touch pad, a second voicemail number associated with a second virtual voicemail touch pad, and so on. The database also stores a list including a corresponding voicemail command associated with each key from a plurality of keys for every voicemail virtual touch pad. For example, the list indicates which voicemail command (such as, rewind, pause, fast forward, slower, data/time, faster, delete, reply, save, cancel/exit, help, and finish/skip) is associated with which key from the various keys displayed on the touch pad.

After receiving the voicemail number, the device correlates 460 the voicemail number to a particular voicemail virtual touch pad from various virtual voicemail touch pads stored in the database, based on the voicemail number. The device then retrieves 470 the voicemail virtual touch pad from the database, which further includes retrieving the list from the database and configuring each key from the plurality of keys of the virtual voicemail touch pad with the corresponding voicemail command based on the list. And finally, the device replaces 480 the default virtual touch pad with the voicemail virtual touch pad.

The voicemail virtual touch pad includes a plurality of keys associated with various voicemail commands, such as, rewind, pause, fast forward, slower, data/time, faster, delete, reply, save, cancel/exit, help, and finish/skip. Therefore, by displaying the voicemail commands on a voicemail virtual touch pad, the user does not have to remember which numeric key corresponds to which voicemail command and reduces the chances of erroneous input of a voicemail command by the user.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A communication device for accessing voicemail commands, the communication device comprising:
a user interface for receiving an input and detecting whether the input is associated with dialing a voicemail number;
a display for displaying a voicemail virtual touch pad in response to detecting that the input is associated with dialing the voicemail number, wherein the voicemail virtual touch pad comprises of a plurality of keys and wherein each key from the plurality of keys is associated with a corresponding voicemail command.

2. The communication device of claim 1 further comprising:
a memory for storing a plurality of voicemail numbers and a plurality of voicemail virtual touch pads.

3. The communication device of claim 2, wherein the plurality of voicemail numbers comprises at least the voicemail number and wherein the plurality of voicemail virtual touch pad comprises at least the voicemail virtual touch pad.

4. The communication device of claim 3 further comprising:
a processor for correlating the voicemail number to the voicemail virtual touch pad in the memory and for retrieving the voicemail virtual touch pad from the memory.

5. The communication device of claim 2, wherein the plurality of voicemail numbers comprises at least the voicemail number and a second voicemail number, and wherein the plurality of voicemail virtual touch pad comprises at least the voicemail virtual touch pad and a second voicemail virtual touch pad.

6. The communication device of claim 5 further comprising:
a processor for correlating the second voicemail number to the second voicemail virtual touch pad in the memory and for retrieving the second voicemail virtual touch pad from the memory.

7. The communication device of claim 1 further comprising
a memory for storing a list, wherein the list includes the corresponding voicemail command associated with each key from the plurality of keys.

8. The communication device of claim 7, wherein the list is stored in the memory by a user of the communication device.

9. The communication device of claim 7, wherein the list is stored in the memory by a manufacturer of the communication device.

10. The communication device of claim 1 is a wireless communication device having access to a voicemail system.

11. A method for accessing voicemail commands in a communication device, the method comprising:
displaying a default virtual touch pad;
detecting whether a voicemail number is dialed;
replacing the default virtual touch pad with a voicemail virtual touch pad based on the dialed voicemail number, in response to detecting that the voicemail number is dialed, wherein the voicemail virtual touch pad comprises of a plurality of keys and wherein each key from the plurality of keys is associated with a corresponding voicemail command.

12. The method of claim 11 further comprising:
storing a list in a database of the communication device, wherein the list includes the corresponding voicemail command associated with each key from the plurality of keys;
storing a plurality of voicemail numbers in the database of the communication device; and
storing a plurality of voicemail virtual touch pad in the database of the communication device.

13. The method of claim 12, wherein the plurality of voicemail numbers comprises at least the voicemail number and wherein the plurality of voicemail virtual touch pad comprises at least the voicemail virtual touch pad.

14. The method of claim 13, wherein replacing further comprises:
correlating the voicemail number to the voicemail virtual touch pad in the database; and
retrieving the voicemail virtual touch pad from the database.

15. The method of claim 14, wherein retrieving the voicemail virtual touch pad further comprises:
retrieving the list from the database; and
configuring each key from the plurality of keys of the voicemail virtual touch pad with the corresponding voicemail command based on the list.

16. The method of claim 12, wherein the plurality of voicemail numbers comprises at least the voicemail number and a second voicemail number, and wherein the plurality of voicemail virtual touch pad comprises at least the voicemail virtual touch pad and a second voicemail virtual touch pad.

17. The method of claim 16, wherein replacing further comprises:
correlating the second voicemail number to the second voicemail virtual touch pad in the database; and
retrieving the second voicemail virtual touch pad from the database.

18. The method of claim 12, wherein the list is stored in the database of the communication device by a user of the communication device.

19. The method of claim 12, wherein the list is stored in the communication device by a manufacturer of the communication device.

20. The method of claim 11, wherein the default virtual touch pad comprises of a plurality of numeric keys.
